(19) United States
(12) Patent Application Publication
(10) Pub. No.: US 2006/0065501 A1
(43) Pub. Date: Mar. 30, 2006

(54) Pick-up shoe

(76) Inventor: Fred J. Taylor, Burlington, KY (US)

Correspondence Address: JERROLD J. LITZINGER, 2134 MADISON ROAD, CINCINNATI, OH, 45208, US

(21) Appl. No.: 11/235,034

(22) Filed: Sep. 26, 2005

Related U.S. Application Data
(60) Provisional application No. 60/613,005, filed on Sep. 24, 2004.

(51) Int. Cl. B60L 5/38

(52) U.S. Cl. 191/49

(57) ABSTRACT

A wayside electrical pick-up shoe for operating the discharge of a railcar. The shoe includes a counterweight for biasing the shoe against the rail. The pick-up shoe uses no springs in the design.

### CROSS REFERENCE TO RELATED APPLICATIONS

This application claims benefit from U.S. Provisional Patent Application No. 60/613,005, filed Sep. 24, 2004, which application is incorporated herein by reference.

### BACKGROUND OF THE INVENTION

1. Field of the Invention

This invention relates generally to railcars, and, in particular, to an electrical pick-up shoe for use in unloading a railroad hopper car.

2. Description of the Related Art

Pick-up shoes have long been utilized in the railroad industry to aid in the control of electrical systems on railroad cars. For example, U.S. Pat. Nos. 1,391,255; 2,305,241; 3,509,292; 3,740,498; 4,542,701; and 5,454,456 all teach systems in which power is supplied to the railcar by use of a pick-up shoe which is capable of contacting a trackside third rail which is energized.

U.S. Pat. No. 6,227,123 teaches a pick-up shoe which includes a spring biased electrical contact pivotally attached to a base plate with a mechanism for electrically insulating the base plate from the electrical contact. The electrical contact is spring biased such that it is maintained in sliding contact with the trackside actuator when in use.

This type of pick-up shoe design suffers from several drawbacks. First, it uses a spring to keep the electrical contact positioned against the trackside actuator. When the electrical contact is in its retracted position, the spring is compressed. As the pick-up shoe is shifted from its active position to its retracted position very frequently, this spring will eventually deteriorate, and must be replaced as a worn spring which has lost its tension will not properly hold the electrical contact against the trackside third rail, causing operating problems.

In addition, this design of this pick-up shoe requires that the electrical contact keep in sliding engagement with the third rail. This tends to cause premature wear on the electrical contact, possibly leading to failure and eventual replacement.

### SUMMARY OF THE INVENTION

It is therefore an object of the present invention to provide an electrical pick-up shoe which is durable and long-lasting.

It is a further object of the present invention to provide an electrical pick-up shoe which does not use springs in its design.

It is a still further object of the present invention to provide an electrical pick-up shoe which is inexpensive and can be easily installed on existing railcars in addition to new car construction.

These and the objects of the present invention will be more readily apparent from the description and drawings which follow.

### BRIEF DESCRIPTION OF THE DRAWINGS

FIG. 1 is an elevational side view of a railroad pick-up shoe according to the present invention;

FIG. 2 is a front view of the pick-up shoe shown in FIG. 1;

FIG. 3 is a top view of the pick-up shoe shown in FIG. 1;

FIG. 4A is a top view of the contact holder for the pick-up shoe of the present invention;

FIG. 4B is a front view of the contact holder shown in FIG. 4A;

FIG. 4C is a side view of the contact holder shown in FIG. 4A;

FIG. 5A is a top view of the contact for the pick-up shoe of the present invention;

FIG. 5B is a front view of the contact shown in FIG. 5A;

FIG. 6A is a top view of the coupling bracket for the pick-up shoe of the present invention;

FIG. 6B is a front view of the coupling bracket shown in FIG. 6A;

FIG. 6C is a side view of the coupling bracket shown in FIG. 6A;

FIG. 6D is a bottom view of the coupling bracket shown in FIG. 6A;

FIG. 7 is an elevational side view of a pick-up shoe according to the present invention shown mounted in position on a railcar;

FIG. 8 is an elevational side view of the pick-up shoe of FIG. 7 shown in the active position and shifted toward the inactive position;

FIG. 9 is an elevational side view of the pick-up shoe of the present invention shown mounted on a railroad car sitting on a railroad track.

FIG. 10 is an elevational side view of the pick-up shoe of the present invention shown mounted on a railroad car traveling along a railroad track.

### DESCRIPTION OF A PREFERRED EMBODIMENT

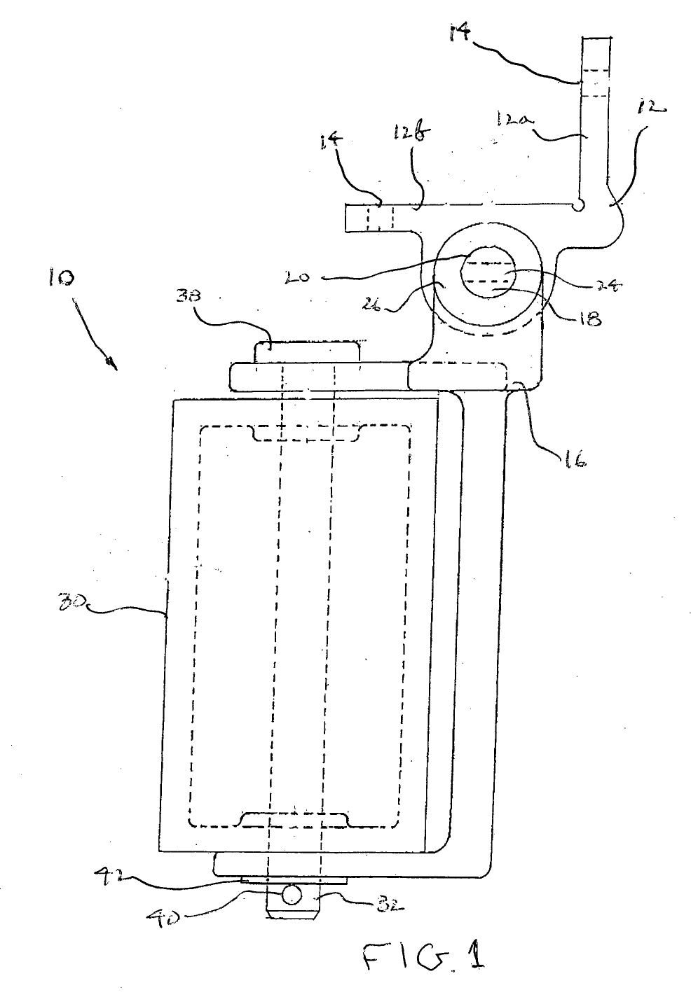

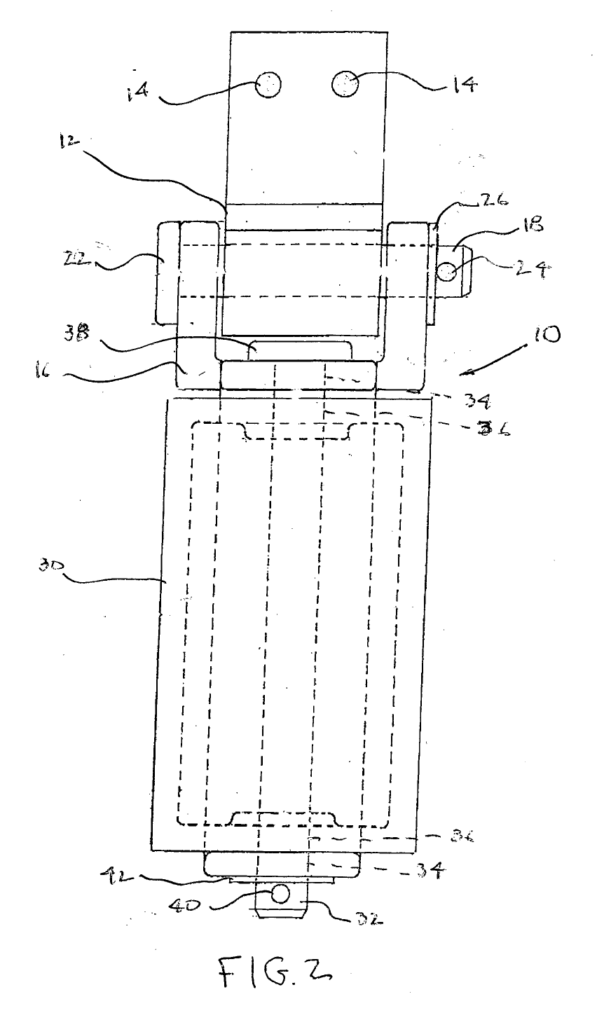

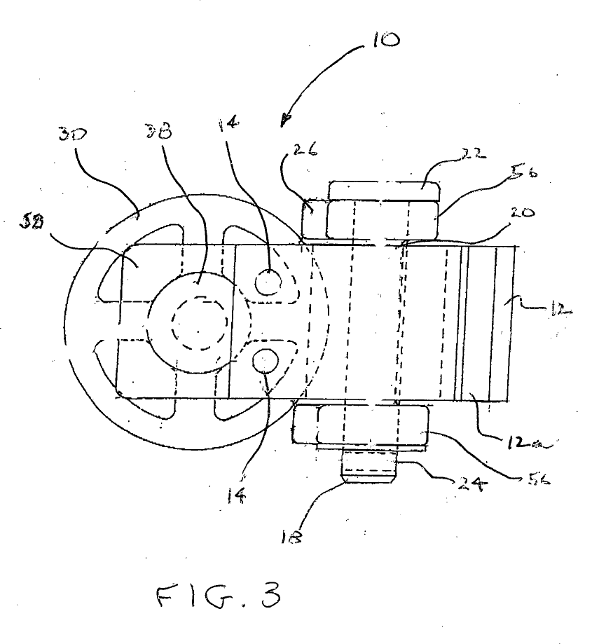

The pick-up shoe of the present invention can be clearly seen in FIGS. 1-3. Referring now to FIG. 1, a pick-up shoe, generally indicated at 10, is shown attached to an insulating bracket 12 which is rigidly affixed to a railcar by a plurality of fasteners which extend through a plurality of openings 14. Bracket 12, which consists of a first section 12a and a second section 12b perpendicular to section 12a, is coupled for rotation to a contact holder 16 by a pin 18 which passes through a pair of openings 20 within holder 16. Pin 18, which contains a head 22 and a through aperture 24, is preferably held in place by a washer 26 and a cotter pin (not shown) or the like inserted through aperture 24. Bracket 12 is constructed from a non-conductive material such as plastic or another similar polymer to electrically isolate pick-up shoe 10 from the body of the railcar.

An electrical contact 30 is rotatably fastened within contact holder 16. Contact 30, which constitutes a tubular electrode, is positioned within holder 16 by a pin 32 such that contact 30 can rotate within holder 16 around pin 32, which passes through openings 34 within holder 16 and openings 36 within contact 30. Pin 32, which contains a head 38 and a through aperture 40, is preferably held in place by a washer 46 and a cotter pin (not shown) or the like inserted through aperture 40.

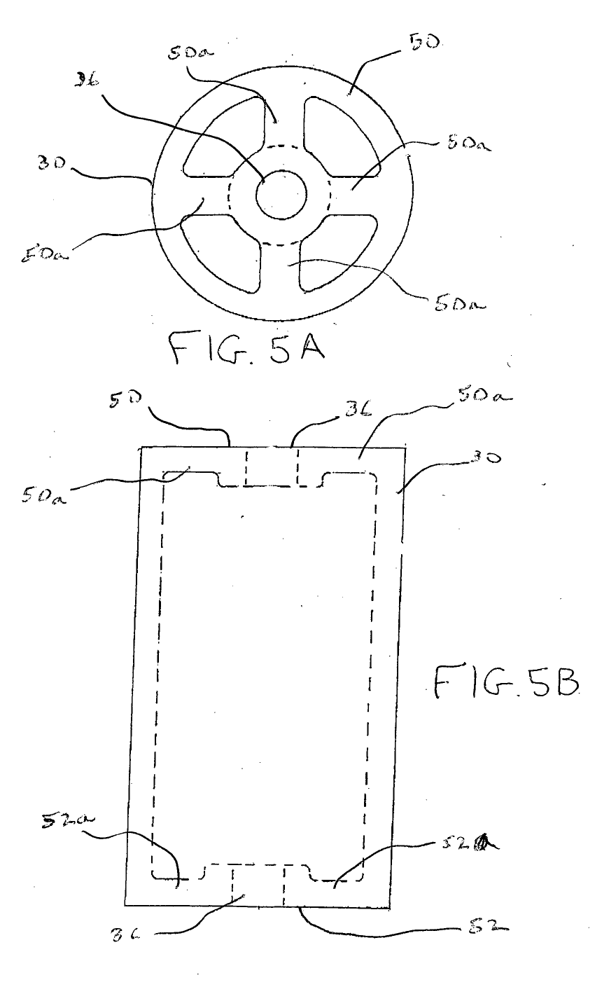

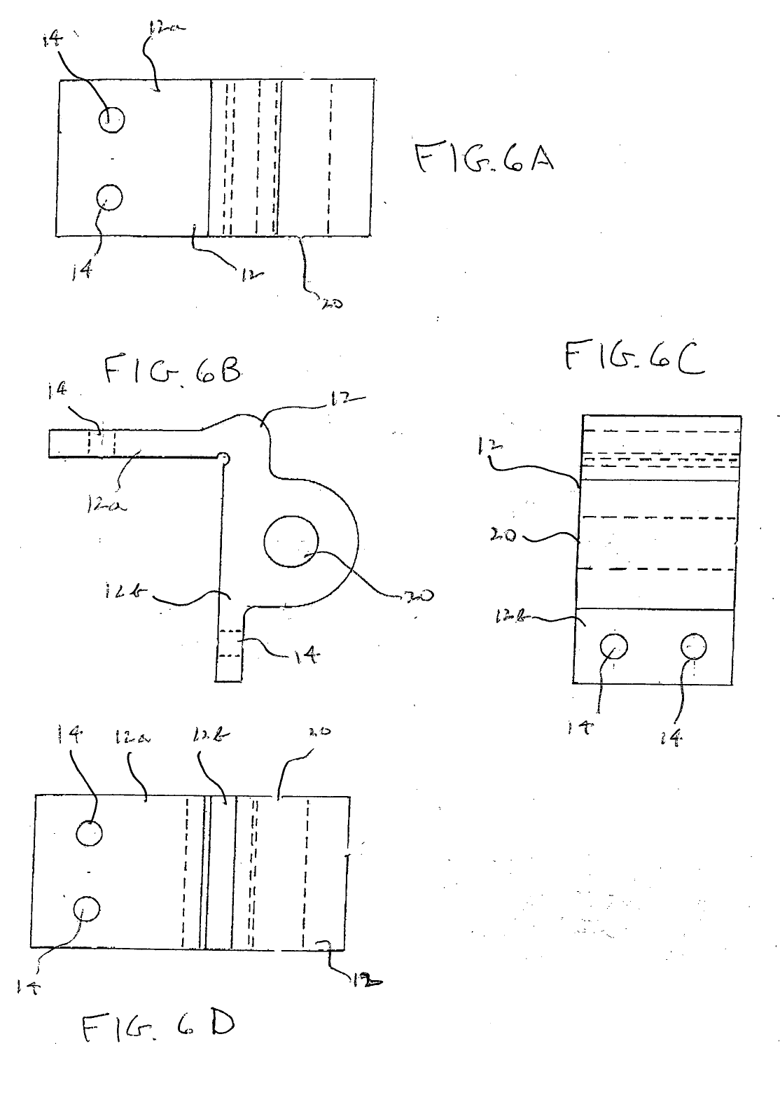

Contact 30 contains an upper center section 50, having a plurality of ribs 50a and a lower center section 52 having a plurality of ribs 52a (see FIGS. 5A and 5B). Contact 30 is manufactured from a conductive material and acts as a commutator switch between the trackside rail and the railcar itself.

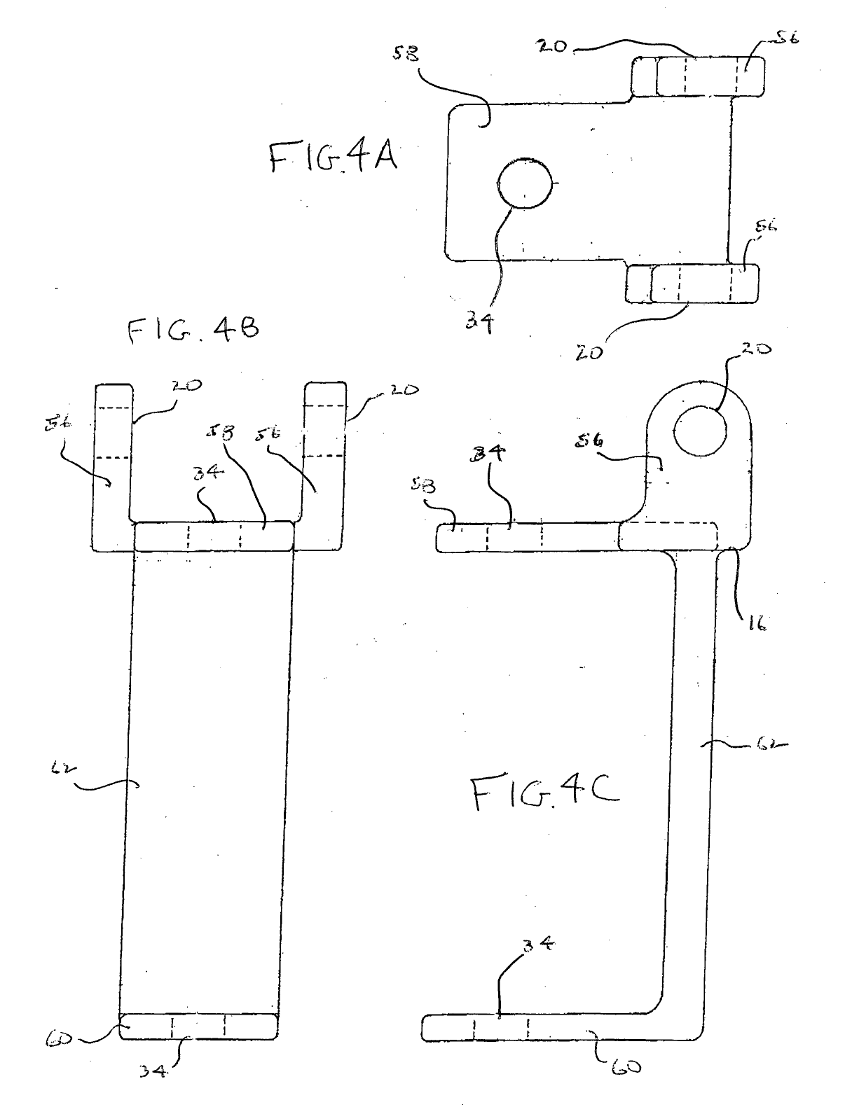

Referring now to FIGS. 4A-C, the construction of contact holder 16 is now described. Contact holder 16 consists of a pair of extensions 56, each of which contains aperture 20 for coupling holder 16 to bracket 12. The body of holder 16 consists of section 58, a bottom section 60 and a central section 62 connecting sections 58 and 60 on one side. Sections 58 and 60 each contain an opening 34 used to mount contact 30 within holder 16.

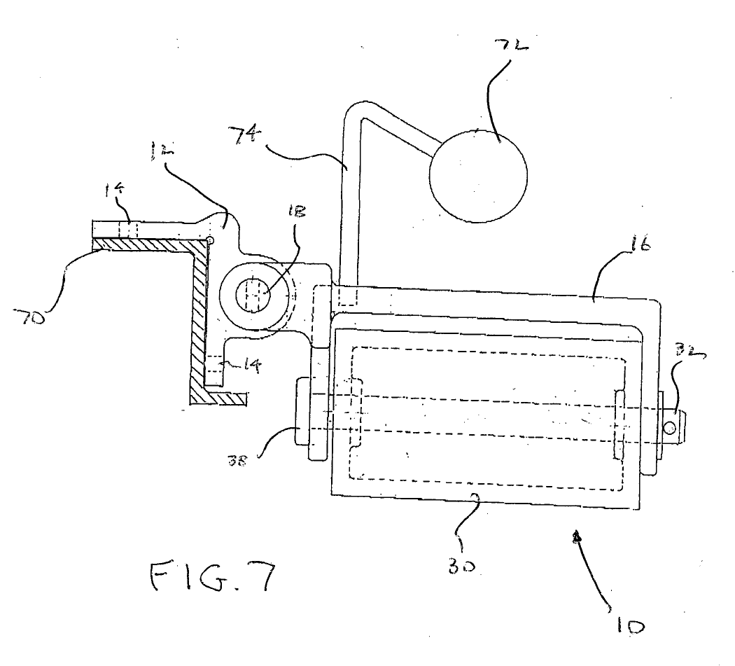

FIGS. 7-9 show the pick-up shoe of the present invention attached to a railroad car. Referring now to FIG. 7, a railroad car section 70 is shown in its operating position affixed to pick-up shoe 10 using fasteners which pass through openings 14 of bracket 12. Alternatively, item 70 may be a separate bracket which attaches directly to the railroad car. A counterweight 72 is attached to contact holder 16 by an arm 74. Counterweight 72 acts to hold contact 30 in constant rolling contact with the trackside rail while the car is in motion when it is desired to provide electrical power to the railroad car. Counterweight 72 may weight up to four pounds in this embodiment.

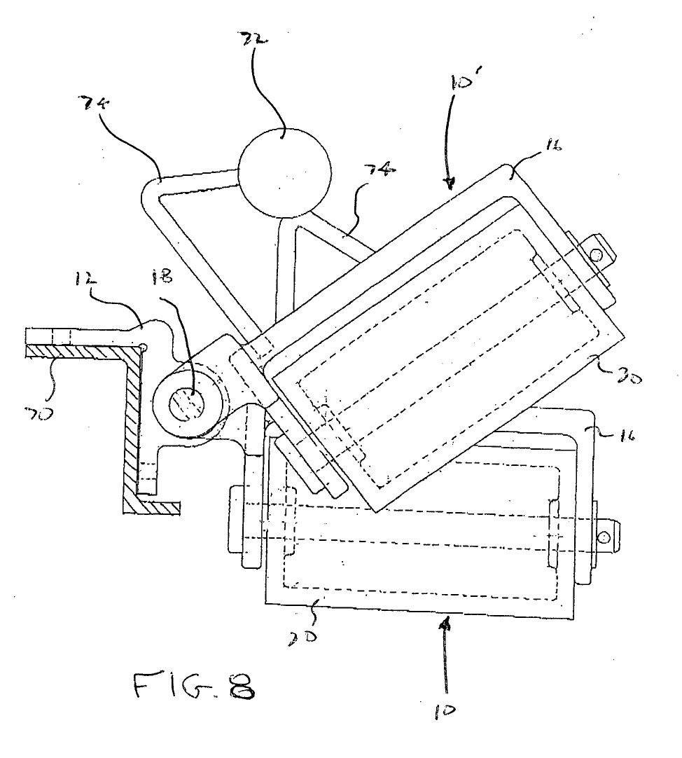

FIG. 8 shows pick-up shoe 10 in both its operating position and an intermediate position shifted away form the trackside rail where pick-up shoe 10 is inoperative. Pick-up shoe 10 is shown in the operating position, while shoe 10 has been pivoted about pin 18 in a counterclockwise direction such that contact 30 is no longer in rolling contact with the trackside rail. Note that as counterweight 72 is attached to shoe 10, it tends to pull shoe 10′ toward the rail, thus shoe 10′ must be held in this position or it will move back into contact with the rail.

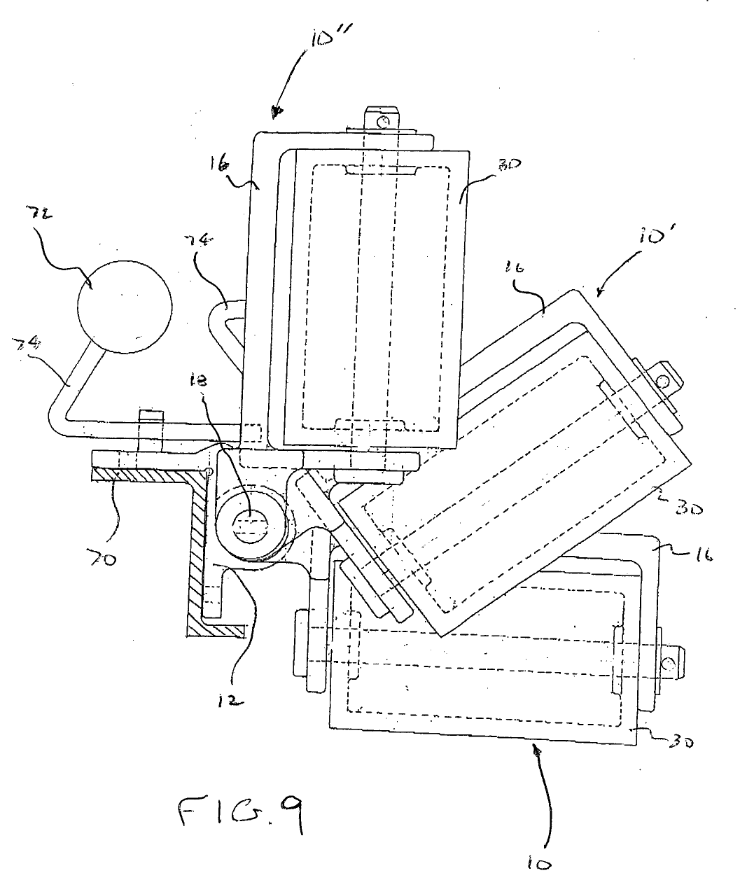

FIG. 9 shows the pick-up shoe of the present invention in three positions: the operating position (as shoe 10), the intermediate position (as shoe 10′), and its inactive position (as shoe 10″). When shoe 10″ is in the inactive position, it is held in place by a latch 80, which holds arm 74. Pick-up shoe 10′ is fixed in the inactive position whenever it is not in use providing operating power to the railroad car.

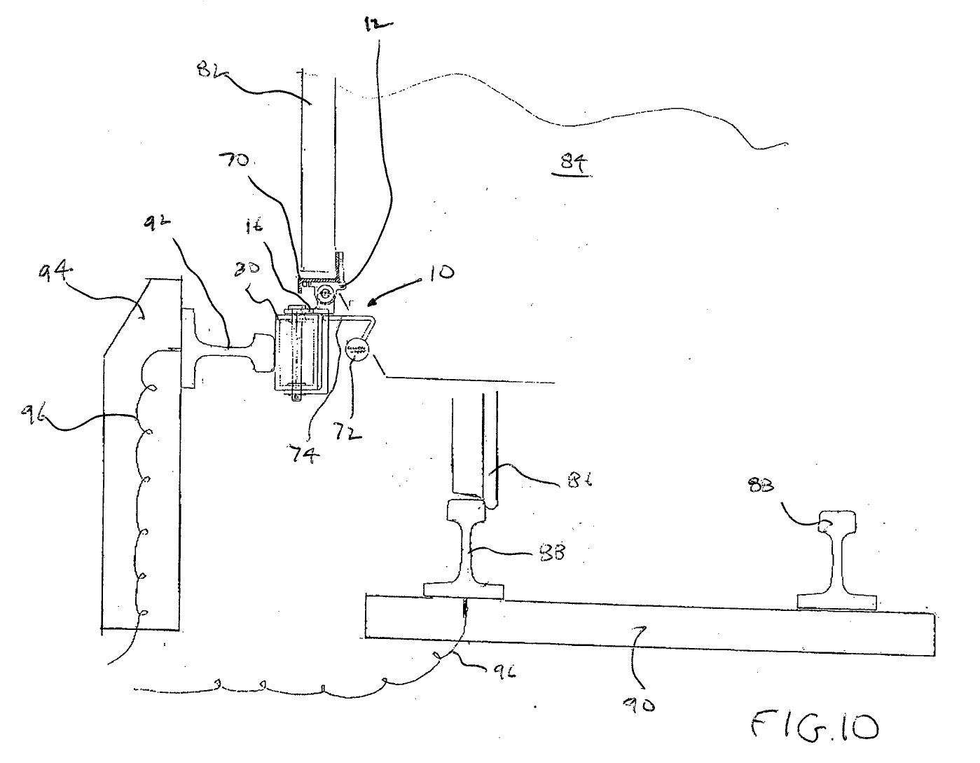

FIG. 10 shows the pick-up shoe of the present invention in operation, providing operating power to a railroad car. Referring now to FIG. 10, pick-up shoe 10 is affixed to a side panel 82 of a metal railroad car 84 having a metal wheel 86 which travels along one of a set of metal rails 88 which are attached to a series of railroad ties 90. A trackside third rail 92 is mounted on a support 94 along the edge of rails 88. A pair of conductors 96 are connected to rail 92 and also to rail 88. As railroad car moves along rails 88, contact 30 of shoe 10 maintains rolling contact with rail 92 which is electrified through conductor 88. The current path is completed by virtue of car body 84 and wheel 86, which constantly contacts rails 88, and conductor 96. Shoe 10 is electrically isolated from car 84 as bracket 12 is composed of a non-conductive material. Thus, electrical current is available on the railroad car to operate a valve in the like which may be used to operate a discharge mechanism for opening and closing the doors of the hoppers.

The fact that contact 30 is in constant rolling contact with rail 92 during operation, wear on the contact is greatly reduced as compared to an electrical contact in sliding contact with the rail, greatly increasing the operating life of shoe 10. In addition, the use of counterweight 74 to insure proper consistent contact for shoe 10 with rail 92 provides a reliable way to provide power to the railroad car without the use of openings, which will fatigue after a limited number of usages.

In the above description, and in the claims which follow, the use of such words as “left”, “right”, “clockwise”, “counterclockwise”, “distal”, “proximal”, “forward”, “outward”, “rearward”, “vertical”, “horizontal”, and the like is in conjunction with the drawings for purposes of clarity.

While the invention has been shown and described in terms of preferred embodiment, it will be understood that this invention is not limited to this particular embodiment, and that many changes and modifications may be made without departing fro the true spirit and scope of the invention as defined in the appended claims.

What is claimed is:

1) A wayside electrical pick-up shoe for a railcar, comprising:
a base plate adapted to be attached t the railcar;
an electrical contact attached to the base plate;
means for insulating the electrical contact from the base plate;
and means for biasing said contact into physical contact with said wayside rail.
